(19) United States
(12) Patent Application Publication
(10) Pub. No.: US 2017/0000163 A1
(43) Pub. Date: Jan. 5, 2017

(54) Method of Increasing Feed Intake of an Animal

(71) Applicant: Once Innovations, Inc., Plymouth, MN (US)

(72) Inventor: Zdenko Grajcar, Orono, MN (US)

(21) Appl. No.: 15/198,096

(22) Filed: Jun. 30, 2016

Related U.S. Application Data
(60) Provisional application No. 62/188,164, filed on Jul. 2, 2015.

(51) Int. Cl. A23K 20/179; A01K 61/02; F21V 9/16; A23K 50/75; A23K 50/80; A01K 39/01; A01K 63/06

(52) U.S. Cl. CPC A23K 20/179; A01K 39/01; A01K 61/025; A01K 63/06; A23K 50/75; A23K 50/80; F21V 9/16

(57) ABSTRACT

A method of increasing feed consumption in avian and aquatic life utilizing an artificial light source. For both avian and the aquatic life an enclosure is provided that houses the animal. An artificial lighting source is utilized to cause feed to emit light having a spectrum under 400 nm such that the animals locate and are attracted to the feed for consumption.

### CLAIM OF PRIORITY

This patent application is based upon and claims the benefit of priority of U.S. Provisional Patent Application Ser. No. 62/188,164, entitled “Method of Increasing Feed Intake of an Animal” filed on Jul. 2, 2015, which is hereby incorporated by reference herein in its entirety.

### BACKGROUND

Indoor agricultural continues to increase across the nation. In particular, most chicken and swine are now grown indoors in a controlled environment. Similarly, aquaculture is also beginning to move indoors. As these indoor facilities continue to emerge ways to improve survival, feed conversion and improve well-being of the animal is desired.

One main problem animals have, especially young animals is finding food sources. In particular, chicken and many species of fish simply have a difficult time locating food. As a result many young animals will either have low body weights from lack of eating causing poor feed conversion rates or alternatively die. Specifically, with the avian, while some simply starve, others become hungry and more aggressive in search of food at a time when food is available. With fish species, the lack of recognition of food can result in up to a 40% mortality rate in certain species.

Those in the avian arts have attempted to address this problem through lighting. In particular feeder lights are used in order to shine light directly on food to emphasize the food for the avian. Another technique as seen in U.S. application Ser. No. 13/357,330, now published as U.S. Pat. Publ. no. 2012/0186524, by Grajcar, which is incorporated in full herein, utilizes differential lighting or two different colored lighting, one shown to attract the avian toward food another shown to discourage an avian from going to a certain location. In this manner the birds are encouraged to migrate toward areas where feed is located and away from area where food is not located.

Still, problems remain. Feed cannot always be delivered to a specific locating and can get scattered through a system. In addition, having specific feeder lighting can add unneeded expense. Thus, a need in the art for other solutions is desired.

### Overview

This application relates to feeding animals. More specifically, this application relates to methods of using light to enhance the feed intake and survivability of animals. A principle object of the present invention is to provide methods to increase food consumption of animals. Yet another object of the present invention is to decrease mortality in animals living in indoor facilities.

A method of increasing feed consumption in avian and aquatic life utilizing an artificial light source. For both avian and the aquatic life an enclosure is provided that houses the animal. An artificial lighting source is provided for emitting light into the enclosure and onto the feed of the animal. The light emitted by the light source has a spectrum that has a range of wavelengths below 400 nm to attract the animal to the feed to increase consumption of the feed.

In one embodiment the food elements of the feed are formed with a fluorescent additive that is digestible by the animal and either reflects light with a spectrum having wavelengths below 400 nm so such light is emitted from the food element or the fluorescent additive receives light with a spectrum having wavelengths above 400 nm and reemits such light in a spectrum having wavelengths below 400 nm. In each instance the animals sees the light emitted by the food element causing the animals to be attracted to the food element and consume the food element thus enhancing food consumption.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a cross-sectional view of an enclosure containing an aviary system and having an illumination system;

FIG. 2 shows an artificial lighting source of an illumination system;

FIG. 3 is a schematic diagram of a circuit for an artificial lighting source of an illumination system;

FIG. 4 shows a schematic view of an enclosure containing and aquatic system and having an illumination system.

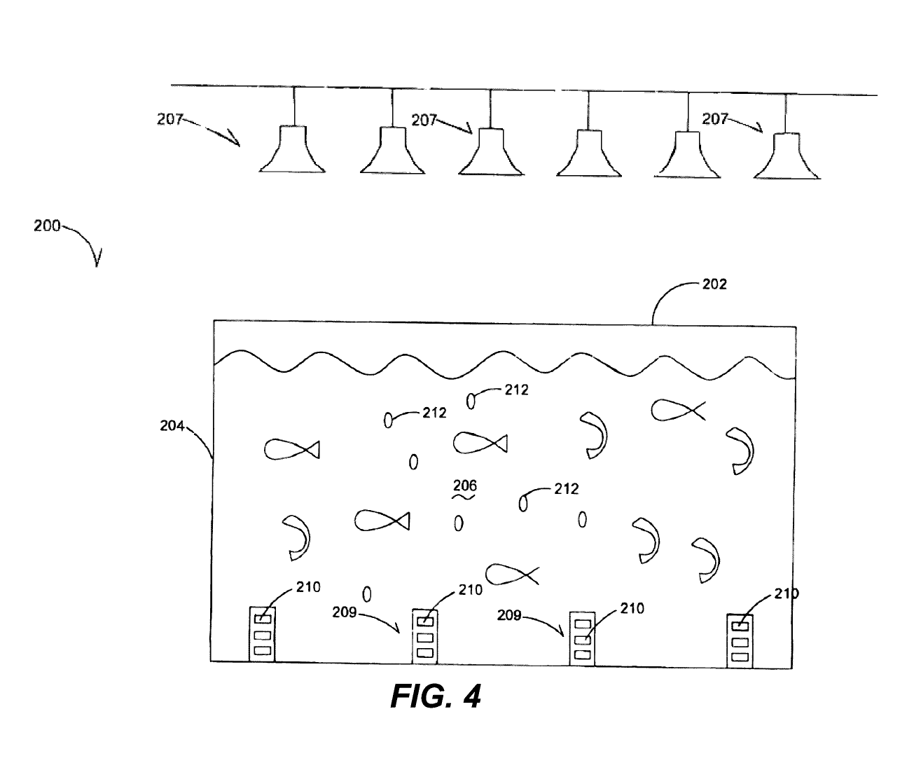

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Behavioral and physiological studies show that animal behavior is influenced by exposure to light in general, and to particular wavelengths of light in particular. For example, exposure to red light (or to light having a red hue) can increase the growth rate of chickens and turkeys at the beginning of the rearing period, increase locomotion that helps minimize leg disorders in the late rearing period, stimulate and promote sexual activity, and reduce feed consumption per egg laid with no differences in egg size, shell weight, shell thickness, or yolk and albumen weights. However, the exposure to red light (or to light having a red hue) can promote cannibalism in broilers. On the other hand, exposure to green and blue light (or to light having green or blue hues) can significantly enhance the animals' growth rate at an early age by enhancing proliferation of skeletal muscle satellite cells, enhance growth at a later age by elevating plasma androgens (in the case of blue light), promote myofiber growth due to more effective stimulation of testosterone secretion, reduce locomotion (in the case of narrow band blue light), and reduce cannibalism rates at late age in broilers (in the case of narrow band blue light).

Light, and more particularly the color or spectrum of light, may therefore be used to influence the behaviors of animals. As used herein, light generally refers to electromagnetic radiation, and more particularly to radiation having wavelengths in the range of 300 to 800 nanometers (nm). The human eye is sensitive to radiation having wavelengths in the range of 400 to 700 nm, with a peak of sensitivity at around 550 nm (corresponding to green light). However, animals including but not limited to avian, fish and other aquatic animals see and react differently to light and different spectrum of light than humans, including seeing a greater range of spectrum.

For example only, domestic fowl are sensitive to a broader range of wavelengths both through their eyes, and through their skulls using receptors located in the pineal gland and in the hypothalamus. In particular, domestic fowl are sensitive to light having wavelengths in the range of 300 to 800 nm. Domestic fowls have peak sensitivities to light having wavelengths of around 480 nm (corresponding to blue light), 570 nm (corresponding to green-yellow light), and at 630 nm (corresponding to red light). As such, we refer to light as any radiation in a range of 300 to 800 nm to which animals are visually sensitive (e.g., through eyes) or physiologically sensitive (e.g., through other receptors, such as receptors in the pineal gland and hypothalamus), including radiation commonly referred to as ultra-violet (UV) and infrared (IR).

Light can have different spectrums or spectral contents depending on the particular mixture and relative intensity of wavelengths included in the light. For example, white light (such as natural daylight) generally has a spectrum including a mixture of radiations from 300 to 800 nm at relatively similar intensities. Red light (or redish light) has a spectrum predominantly (or only) including radiation having wavelengths in the “red” range of 635-700 nm (and more generally, wavelengths over 620 nm). Blue light (or bluish light) has a spectrum predominantly (or only) including radiation having wavelengths in the “blue” range of 450-490 nm (and more generally, wavelengths below 500 nm). Green light (or greenish light) has a spectrum predominantly (or only) including radiation having wavelengths in the “green” range of 490-560 nm. For additional examples also see U.S. Pat. No. 8,596,804 entitled “Light Sources Adapted to the Spectral Sensitivity of Diurnal Avians and Humans” to Grajcar, which is incorporated by reference in full herein, and U.S. Pat. No. 8,643,308 entitled “Spectral Shift Control for Dimmable AC LED Lighting” to Grajcar, which is also incorporated by reference in full herein.

A light spectrum predominantly includes radiation of a particular wavelength or range of wavelengths if the relative luminous power (or energy content) of those particular wavelength(s) is higher than the luminous power (or energy content) of other wavelengths in the light spectrum. However, alight that is substantially of a given color can including radiation having a range of wavelengths of the given color, as well as radiation of other wavelengths.

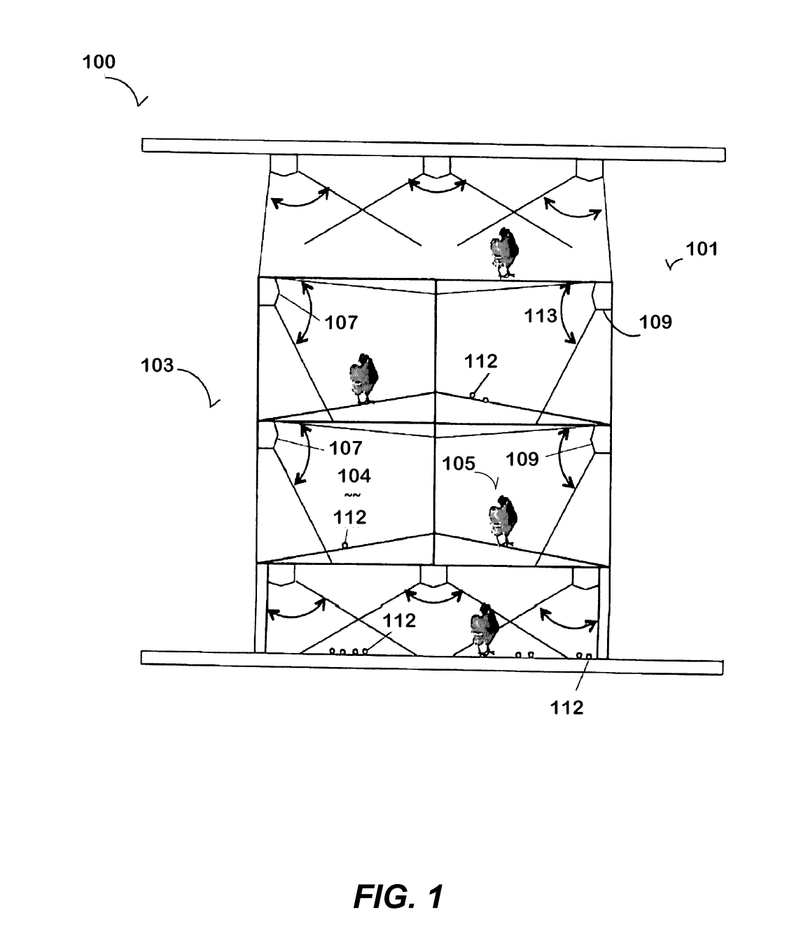

As a first example of a system 100 for feeding an animal FIG. 1 shows a cross-sectional view of an enclosure 101 containing an aviary system 103 for housing animals. The enclosure 101 may be one of many enclosures included in an egg production facility and having a differential illumination system. Each enclosure 101 houses a group of animals that can move within the enclosure, but are restricted from moving between different enclosures. The enclosure 101 includes one or more aviary systems 103 located within the enclosure. The chicken 105 or other poultry or animals housed in the enclosure 101 can move freely between the enclosure 101 and the aviary system 103 through one or more openings in the aviary system 103.

An aviary system 103 is a structure for housing chicken 105 or other poultry or animals in an interior volume 104 thereof, and for providing various services to the chicken. The aviary system 103 can include supply lines, augers, and/or belt conveyors for conveying inputs to and outputs from the system. For example, the aviary system 103 can supply feed, water, and/or light to the chicken, and can remove litter and recover eggs laid by the chicken. The interior volume 104 of the aviary system 103 can thus include different areas or systems designed or designated for different purposes. For example, the aviary system 103 can include a nest area for laying eggs, one or more feeding or drinking areas for providing food or water to the chicken, one or more roosting areas, or the like.

The enclosure 101 may also include different areas or systems designed or designated for different purposes. For example, the enclosure 101 can include a scratching area, located for example on a floor of the enclosure 101 (e.g., a portion of the floor located underneath the aviary system 103, a portion of the floor located next to or around the aviary system, in an aisle between two or more aviary systems 103, or the like), on top of an aviary system 103 within the enclosure 101, outside of a barn in a case in which the enclosure 101 includes an outdoor section, or the like. The scratching area may be designed for use in scratching, pecking, and/or dust bathing. In some examples, the enclosure may additionally or alternatively include one or more perches or roosting areas separate from the aviary system 103.

Various light sources 107, 109 may be installed to provide illumination in the enclosure 101 and in the aviary system 103. The light sources 107, 109 may be incandescent bulbs, fluorescent lights, light-emitting diode (LED), or other suitable lamps. Each light source 107, 109 produces light with a particular spectrum or selection of radiation wavelengths. In some examples, the light sources 107, 109 may be directional light sources. Directional light sources produce a directed beam of light having a given width or angle 113 (e.g., a beam angle less than 60 degrees), and are designed to predominantly (or only) provide illumination in a given direction or location.

Each light source 107, 109 produces light with a particular spectrum or selection of radiation wavelengths. As a result, one light source (or group of light sources) can produce light having one color or spectrum, while another light source (or group of light sources) can produce light having a different color or spectrum. Additionally, a single light source (or group of light sources) can selectively produce light having a different color or spectrum at different times e.g., the light source can be controlled to produce light of one color now, and to produce light of a different color at another later time).

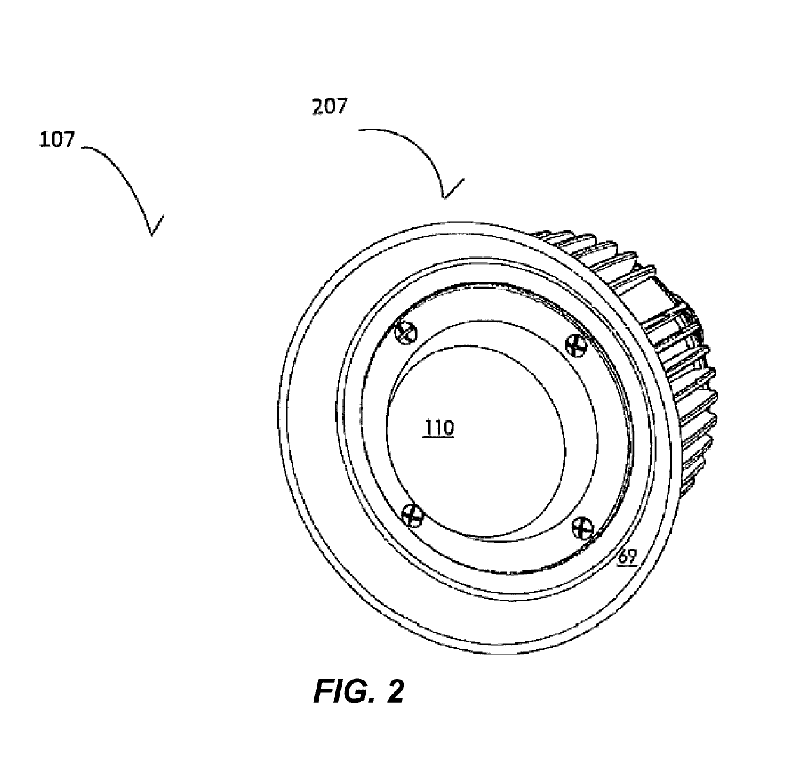

In an example embodiment depicted in FIG. 2, the light sources 107 and 109 each have individual lighting elements 110 that emit light at a pre-selected wavelength. In one embodiment the pre-selected wavelength in an ultraviolet A (UVa—320 nm-400 nm) lighting element 110. Specifically, in one embodiment the lighting element 110 emits UVa light in a range between 380-400 nm that is visible to the avian to increase light output to the avian. In another embodiment the lighting element 110 is in a UVa range that is not visible to the avian.

In either embodiment a food element 112 having a fluorescent organic material therein is provided. The fluorescent additive includes, but is not limited to fluorescent food coloring, editable fluorescent paint, a fluorescent chemical added during the creation of the feed or the like. The fluorescent organic material is pre-determined or pre-selected to relate to the wavelength selected and emitted by at least one lighting element 110. In one embodiment the fluorescent organic material is a phosphorous fluorescent material that receives the wavelength of the lighting element 110 and reemits light at a wavelength within 15 nm of a peak sensitivity of the avian or within 15 nm of a wavelength known to cause a predetermined biological or physiological response in the avian.

In this manner the organic material within the food element 112 in one embodiment fluoresces at a wavelength known to attract the avian to the food element. In this manner every food element, regardless of location, if under the light sources 107 and 109 illuminates to facilitate the finding of the food element 112 by the avian, ensuring optimum feed conversion and minimizing mortality as a result of cannibalism or aggressive behavior as a result of lack of food.

In another embodiment the organic material is either added to or is part of the food element 112 and reflects light emitted by the light sources 107 or 109. In this manner the lighting elements 110 are pre-determined or pre-selected at a wavelength that is within 15 nm of a peak sensitivity of the avian or within 15 nm of a wavelength known to cause a predetermined biological or physiological response in the avian. Thus the light is reflected by the food element 110 and seen by the avian. Again facilitating the finding of the food element 112 by the avian, ensuring optimum feed conversion and minimizing mortality as a result of cannibalism or aggressive behavior as a result of lack of food.

In addition another advantage is realized. Specifically when a lighting element 110 emits UVa light an auxiliary light source 114 that is transient, such as a black light can be utilized to identify bio material in the enclosure 101, including but not limited to urine, feces and blood. In this manner enhanced cleaning can be accomplished under the light sources 107 and 109.

The light sources 107, 109 may also be dimmable, such that the intensity of illumination produced by a light source can be selected or changed. Additionally, a single light source can selectively produce light having a different color at different dimming levels (e.g., the light can produce a white light at high lighting intensities, and a redish light when dimmed to a lower lighting intensity). The color (or spectrum) and intensity of a group of multiple light sources may be controlled together: as such, all light sources 107 providing illumination outside of the aviary system 103 may be controlled together (such that they all provide a similar color and intensity of lighting), while all light sources 109 providing illumination inside of the aviary system 103 may be controlled together.

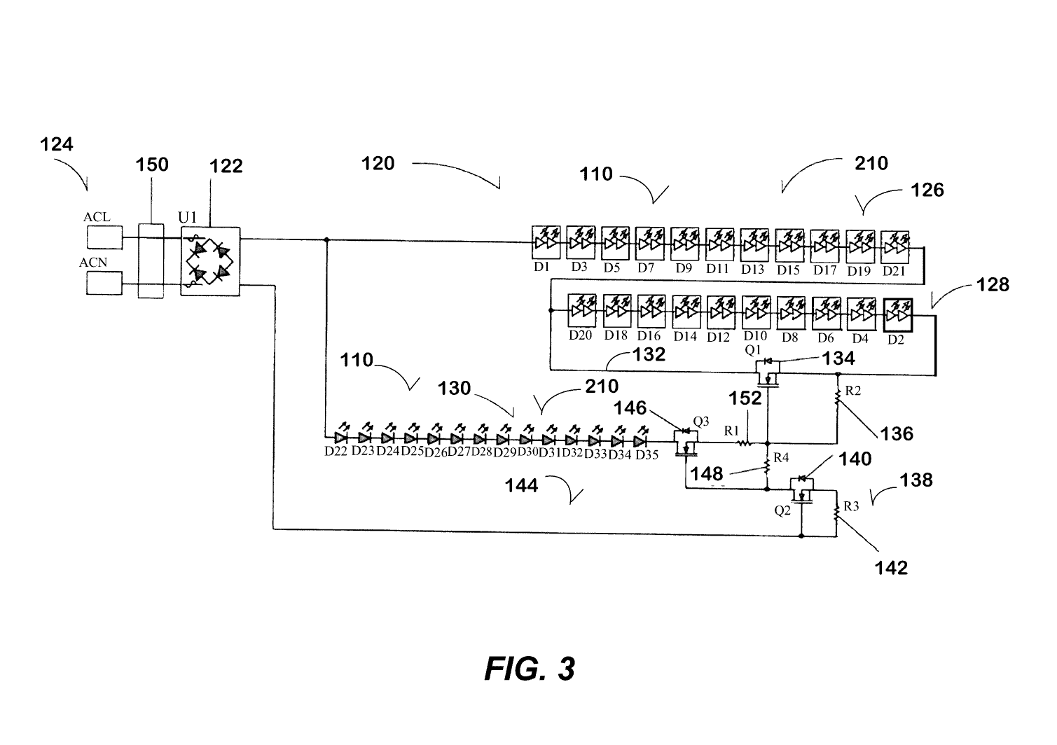

FIG. 3 provides a schematic diagram of a circuit able to providing the lighting requirements of the present disclosure. The circuitry 120 of the present invention includes a rectifying device 122 that receives current from an AC source 124 and includes a first group of light emitting diodes 126 arranged in series with a second group of light emitting diodes 128, both of which comprise diodes emitting white light or a composite white light. A third group of light emitting diodes 130 comprise diodes emitting either light having a spectrum under 400 nm, including but not limited to light between 320 nm and 400 nm and more specifically between 380 nm and 400 nm or light that when received by a food element 112 having a fluorescent material therein causes the fluorescent material to emit light having a spectrum under 400 nm, including but not limited to light between 320 nm and 400 nm and more specifically between 380 nm and 400 nm. This third group of light emitting diodes are presented in parallel to the first and second groups of diodes 126 and 128. The threshold voltage of the third group of light emitting diodes 130 in one embodiment is set lower than the threshold voltage of the first group of light emitting diodes 126 such that the third group of light emitting diodes 130 turn on first as voltage is increased.

A bypass path 132 is presented with a first impedance element 134 that in one embodiment is a transistor. In a preferred embodiment the first impedance element 134 is a depletion MOSFET, though a p-channel MOSFET, n-channel MOSFET or the like can be used without falling outside the scope of this disclosure, even if an additional transistor is required for functionality purposes. A first resistor 136 is also provided to control the flow of current through the first impedance element 134 to provide smooth and continuous current flow.

A current path 138 is also provided with a second impedance element 140 that similarly in one embodiment is a depletion MOSFET. Similar to the bypass path 132 the current path 138 utilizes a second resistor 142 again to control the impedance element 140. Similarly also, a current path 144 is provided between the third group of light emitting diodes 130 and first and second groups of light emitting diodes 126 and 128. Again, this current path 144 utilizes a third impedance element 146 and third resistor 148 to provide similar functionality as the other bypass paths. In particular, this third impedance element 146 acts as a switch to stop the flow of current through the third group of light emitting diodes 130 to eliminate the wavelength of light, such as UV range light emitted by the third group of light emitting diodes 130.

When a dimming device 150 is electrically connected to the circuit and the voltage begins dropping, current flow to the second group of diodes 128 drops before the first group of light emitting diodes 126, dimming out a group of white diodes. Then as dimming continues and a threshold current is reached the first group of light emitting diodes 126 begin to dim. Thus, again white light is slowly dimmed and eliminated from the output light. In this manner only the third group of light emitting diodes 130 that are under 400 nm remain providing light. A supplemental resistor 152 optionally is provided to limit current in the system and to improve efficiencies.

Therefore the assembly dims to produce a light having a spectrum under 400 nm. Consequently, with a programmable dimming device the lighting source 107, 109, 207 or 209 can provide a combination of white and UV light throughout a 24 hour period to optimize feed intake.

In another embodiment a habitat or ecosystem for an aquatic animal is provided. In one embodiment the habitat or ecosystem is an enclosed tank 200 with an open top 202 and enclosure 204 surrounding a volume of water 206 containing the aquatic life. Aquatic life includes, but is not limited to shrimp, crawfish, fin fish, freshwater fish, saltwater fish, trout, sea bass, barramundi, tilapia, lobster, crab or the like.

In this embodiment light sources 207 and 209 are provided. The light sources 207 or 209 can be located at any location to provide light into the tank 200. This includes above the tank 200, at the side through a clear sidewall or within/underneath the volume of water 206.

Similar to the avian embodiment above lighting elements 210 are provided in the light sources 207 and 209 that are a pre-determined or pre-selected wavelength(s) that is related to a food element 212 having an organic material therein or thereon. Again, as with the avian, the organic material is either a phosphorous fluorescent material that absorbs the pre-determined wavelength light emitted by the lighting elements 210 and reemit light at a predetermined wavelength that is either at a wavelength that is within 15 nm peak sensitivity of the species of aquatic life in the volume of water 206 or at a wavelength within 15 nm of a wavelength known to cause a predetermined biological or physiological response of the aquatic life. Alternatively the organic material reflects light at a predetermined wavelength that is either at a wavelength that is within 15 nm of the peak sensitivity of the species of aquatic life in the volume of water 206 or at a wavelength within 15 nm of a wavelength known to cause a predetermined biological or physiological response of the aquatic life.

In this manner, similar to with avian the food element 212 fluoresces to the aquatic life attracting the aquatic life to the food element 212 for consumption. Thus feed conversion is increased, growth optimized and mortality rate reduced. A similar effect is presented for all animals, including swine, and other animals bred or raised under artificial light.

In operation one determines a wavelength or color of light that is most likely to attract the animal to food and cause the animal to consume the food. Once the predetermined wavelength is determined based upon the animal or species of animal, lighting elements for a light source are selected depending upon an organic material within a food element. The organic material either absorbs the selected wavelength and reemits the predetermined wavelength that maximizes the recognition by the animal of the food element to maximize food element intake by the animal, or reflects the pre-selected wavelength that maximizes the recognition by the animal of the food element to maximize food element intake by the animal. The pre-determined wavelength in one embodiment is 480 nm while the pre-selected wavelength of the lighting element is in the UVa range. Alternatively the pre-determined wavelength is 380 nm or above 380 nm.

Thus provided is a system and method of using light to attract animals to food to cause the animal to eat the food. By causing the animal to eat the food feed conversion is improved and mortality decrease. Therefore all of the stated objects have been met.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed:

1. A method of increasing feed consumption of avian, comprising:
providing an aviary system located within an enclosure, wherein the aviary system includes an internal volume for housing avian;
illuminating feed for the avian with a light from an artificial light source having a spectrum that is less than 400 nanometers (nm) to cause the avian to eat the feed.

2. The method of claim 1, wherein the spectrum is between 380 nm and 400 nm.

3. The method of claim 1, wherein the artificial light source has a plurality of light emitting diodes that provide the spectrum.

4. A method of increasing feed consumption of avian, comprising:
providing an aviary system located within an enclosure wherein the aviary system includes an internal volume for housing avian;
illuminating feed for the avian with a light from an artificial light source; and
forming a food element having a fluorescent additive that receives light from the light source and emits light having a spectrum under 400 nm.

5. The method of claim 4, wherein the fluorescent additive is an organic material

6. The method of claim 4, wherein the fluorescent additive reflects the light from the artificial light source.

7. The method of claim 4, wherein the light from the artificial light source has a different spectrum than the light emitted by the fluorescent additive.

8. The method of claim 4, wherein the light emitted by the fluorescent additive has a spectrum under 380 nm.

9. The method of claim 4, wherein the avian is a turkey.

10. A method of feeding aquatic life, comprising:
providing an aquatic system containing water within aquatic life living in the water;
illuminating feed for the aquatic life with a light from an artificial light source; and
forming a food element having a fluorescent additive that receives light from the artificial light source and emits light having a spectrum under 400 nanometers (nm).

11. The method of claim 10, wherein the fluorescent additive is an organic material

12. The method of claim 10, wherein the fluorescent additive reflects the light from the artificial light source.

13. The method of claim 10, wherein the light from the artificial light source has a different spectrum than the light emitted by the fluorescent additive.

14. The method of claim 10, wherein the light emitted by the fluorescent additive has a spectrum under 380 nm.

15. The method of claim 10, wherein the artificial light source is above the water.

16. The method of claim 10, wherein the artificial light source is within the water.
